(19) United States
(12) Patent Application Publication
(10) Pub. No.: US 2013/0155528 A1
(43) Pub. Date: Jun. 20, 2013

(54) OPTICAL LENS SYSTEM FOR IMAGE TAKING

(71) Applicants: Tsung-Han Tsai, Taichung (TW); Ming-Ta Chou, Taichung (TW)

(72) Inventors: Tsung-Han Tsai, Taichung (TW); Ming-Ta Chou, Taichung (TW)

(73) Assignee: LARGAN PRECISION CO., LTD, Taichung (TW)

(21) Appl. No.: 13/445,260

(22) Filed: Apr. 12, 2012

(30) Foreign Application Priority Data
Dec. 19, 2011 (TW) 100147160

(51) Int. Cl. G02B 9/14

(52) U.S. Cl. 359/785

(57) ABSTRACT

An optical lens system for image taking includes, in order from an object side to an image side, a first lens element with positive refractive power having a convex object-side surface, a second lens element with negative refractive power having a concave object-side surface and a concave image-side surface with the at least one surface being aspheric, and a third lens element with positive refractive power having a convex object-side surface and a concave image-side surface with the at least one surface being aspheric. The image-side surface of the third lens element includes at least one inflection point. By adjusting spacing between any two lens elements, the optical lens system for image taking has a desirable space allocation and can effectively correct the Petzval Sum in order to obtain superior imaging quality.

### CROSS-REFERENCE TO RELATED APPLICATIONS

This non-provisional application claims priority under 35 U.S.C. §119(a) on Patent Application No(s). 100147160 filed in Taiwan, R.O.C. on Dec. 19, 2011, the entire contents of which are hereby incorporated by reference.

### BACKGROUND

1. Technical Field

The present disclosure relates to an optical lens system for image taking, and more particularly to a combined optical lens system for image taking.

2. Related Art

In recent years, with the rise of portable electronic device with photographing capability, the demand for compact photographing module is increased. The photo-sensing device of an ordinary photographing camera is commonly selected from a charge coupled device (CCD) or a complementary metal-oxide semiconductor (CMOS) device. In addition, with the advance of semiconductor manufacturing technology enabling the miniaturization of pixel size of sensors, the resolution of a compact optical lens assembly gradually increases so there are increasing demands for the compact optical lens assemblies capable of generating superior imaging quality.

In order to reduce manufacturing costs, a two-lens structure is adopted in a conventional photographic lens assembly. However, the two-lens structure having limited aberration correction capability cannot meet the demand for high-level photographic lens assembly, and the photographic lens assembly with multiple lenses increases the total length of the photographic lens assembly, thereby, affecting miniaturization. In order to improve the imaging quality and miniaturize the overall size, a photographic lens assembly consists of three lens elements is disclosed. For example, U.S. Pat. No. 7,145,736 discloses a lens assembly for an image sensor consists of three lens elements. However, this lens assembly including a concave object-side surface and a concave image-side surface of the second lens element is unfavorable for correcting the Petzval Sum of the lens assembly, thereby, hardly controlling the imaging quality at the peripheral region.

### SUMMARY

According to an embodiment, an optical lens system for image taking comprises, in order from an object side to an image side, a first lens element with positive refractive power, a second lens element with negative refractive power, a third lens element with negative refractive power. The first lens element comprises a convex object-side surface. The second lens element comprises a concave object-side surface and a concave image-side surface. At least one of the object-side surface and the image-side surface of the second lens element is aspheric. The third lens element comprises a convex object-side surface and a concave image-side surface. At least one of the object-side surface and the image-side surface of the third lens element is aspheric, and the image-side surface of the third lens element comprises at least one inflection point.

The optical lens system for image taking satisfies the following condition:

0.6<T₁₂/T₂₃<2.55; (Condition 1)

Wherein T₁₂ is the axial distance between the first lens element and the second lens element; and T₂₃ is the axial distance between the second lens element and the third lens element.

According to another embodiment, an optical lens system for image taking comprises, in order from an object side to an image side, a first lens element with positive refractive power, a second lens element with negative refractive power and a third lens element. The first lens element comprises a convex object-side surface. The second lens element comprises a concave aspheric object-side surface and a concave aspheric convex image-side surface. The third lens element comprises a convex aspheric object-side surface and a concave aspheric image-side surface.

The optical lens system for image taking satisfies Condition 1 and the following condition:

−0.8<R₃/R₄<0; (Condition 2)

−1.05<f/f₂<−0.1; and (Condition 3)

0<|f/f₃|<0.55; (Condition 4)

Wherein T₁₂ is the axial distance between the first lens element and the second lens element; T₂₃ is the axial distance between the second lens element and the third lens element; R₃ is the curvature radius of the object-side surface of the second lens element; R₄ is the curvature radius of the image-side surface of the second lens element; f is the focal length of the optical lens system for image taking; f₂ is the focal length of the second lens element; and f₃ is the focal length of the third lens element.

### BRIEF DESCRIPTION OF THE DRAWINGS

The present disclosure will become more fully understood from the following detailed description when taken in connection with the accompanying drawings, which show, for purpose of illustrations only, and thus do not limit other possible embodiments derived from the spirit of the present disclosure, and wherein:

FIG. 1A is a schematic structural view of a first embodiment of an optical lens system for image taking;

FIG. 1B, FIG. 1C, FIG. 1D are schematic views of longitudinal spherical aberration curves, astigmatic field curves, and a distortion curve, respectively in the optical lens system for image taking in FIG. 1A;

FIG. 2A is a schematic structural view of a second embodiment of an optical lens system for image taking;

FIG. 2B, FIG. 2C, FIG. 2D are schematic views of longitudinal spherical aberration curves, astigmatic field curves, and a distortion curve, respectively in the optical lens system for image taking in FIG. 2A;

FIG. 3A is a schematic structural view of a third embodiment of an optical lens system for image taking;

FIG. 3B, FIG. 3C, FIG. 3D are schematic views of longitudinal spherical aberration curves, astigmatic field curves, and a distortion curve, respectively in the optical lens system for image taking in FIG. 3A;

FIG. 4A is a schematic structural view of a fourth embodiment of an optical lens system for image taking;

FIG. 4B, FIG. 4C, FIG. 4D are schematic views of longitudinal spherical aberration curves, astigmatic field curves, and a distortion curve, respectively in the optical lens system for image taking in FIG. 4A;

FIG. 5A is a schematic structural view of a fifth embodiment of an optical lens system for image taking;

FIG. 5B, FIG. 5C, FIG. 5D are schematic views of longitudinal spherical aberration curves, astigmatic field curves, and a distortion curve, respectively in the optical lens system for image taking in FIG. 5A;

FIG. 6A is a schematic structural view of a sixth embodiment of an optical lens system for image taking;

FIG. 6B, FIG. 6C, FIG. 6D are schematic views of longitudinal spherical aberration curves, astigmatic field curves, and a distortion curve, respectively in the optical lens system for image taking in FIG. 6A;

FIG. 7A is a schematic structural view of a seventh embodiment of an optical lens system for image taking;

FIG. 7B, FIG. 7C, FIG. 7D are schematic views of longitudinal spherical aberration curves, astigmatic field curves, and a distortion curve, respectively in the optical lens system for image taking in FIG. 7A;

FIG. 8A is a schematic structural view of an eighth embodiment of an optical lens system for image taking; and

FIG. 8B, FIG. 8C, FIG. 8D are schematic views of longitudinal spherical aberration curves, astigmatic field curves, and a distortion curve, respectively in the optical lens system for image taking in FIG. 8A.

### DETAILED DESCRIPTION

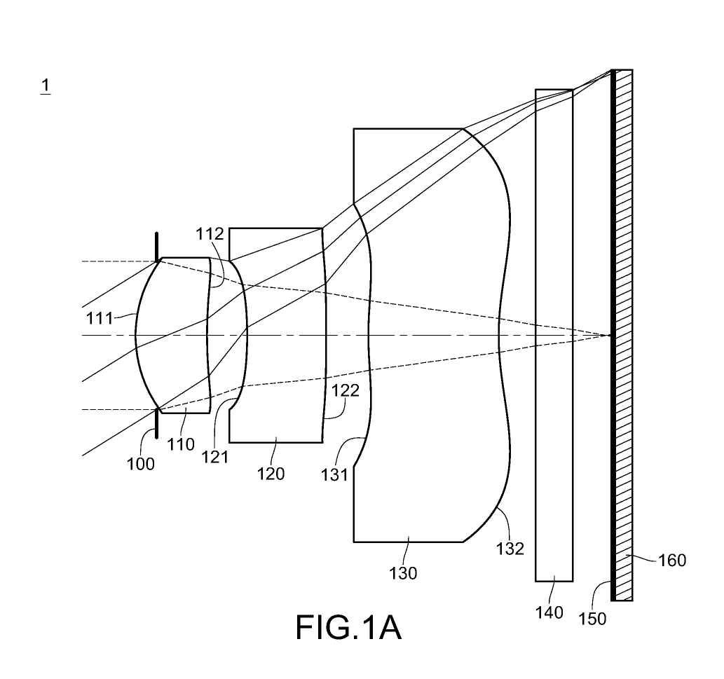

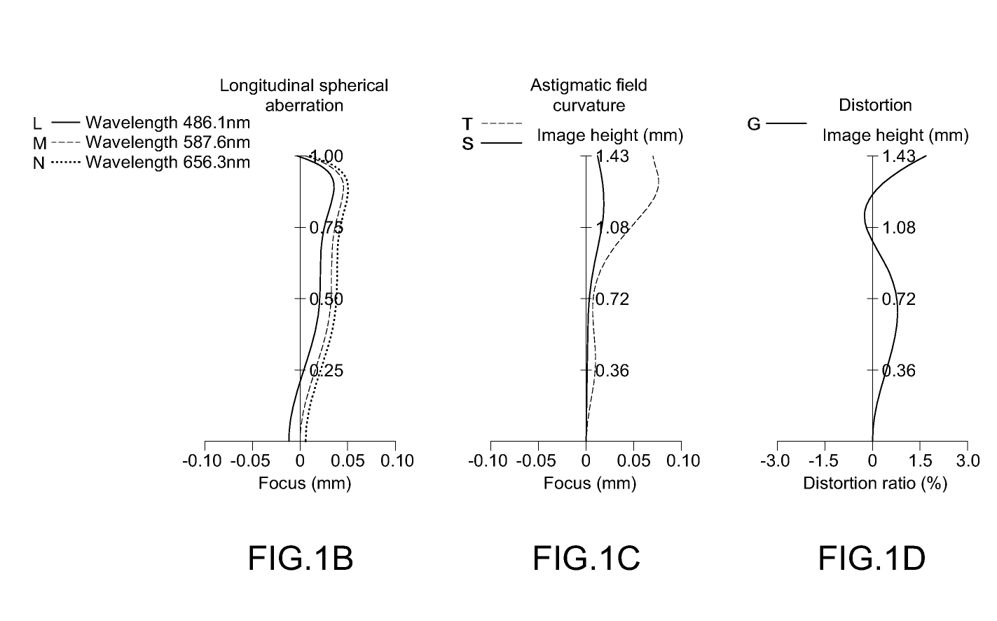

The optical lens system for image taking of the present disclosure is described with FIG. 1A as an example to illustrate that the embodiments have similar lens combinations, configuration relationships, and the same conditions of the optical lens system for image taking. The differences are described in detail in the following embodiments other than the embodiment described in FIG. 1.

Taking FIG. 1A as an example, the optical lens system for image taking 1 comprises, from an object side to an image side along an optical axis (from left to right in FIG. 1A) in sequence, a stop, a first lens element 110, a second lens element 120, a third lens element 130, an infrared filter 140 and an image sensor 160 disposed on an image plane 150. The stop can be an aperture stop 100.

The first lens element 110 comprises an object-side surface 111 and an image-side surface 112. The refractive power of the first lens element 110 is positive for providing a portion of the overall refractive power needed, and reducing the total optical length of the optical lens system for image taking 1. The object-side surface 111 is convex, the positive refractive power of the first lens element 110 is further enhanced which enables the total optical length of the optical lens system for image taking 1 being even shorter.

The second lens element 120 comprises an object-side surface 121 and an image-side surface 122. The refractive power of the second lens element 120 is negative for correcting the aberration of the optical lens system for image taking 1. The object-side surface 121 and the image-side surface 122 are concave, the Petzval Sum is effectively corrected and the field curvature is reduced which enables the image surface in the peripheral region to be even flatter.

The third lens element 130 comprises an object-side surface 131 and an image-side surface 132. The refractive power of the third lens element 130 is negative for making the principal point of the optical lens system for image taking 1 farther away from the image plane 150, and, therefore, reducing the total optical length to maintain the miniaturization of the optical lens system for image taking 1. The object-side surface 131 and the image-side surface 132 are concave for correcting the high order aberration, therefore, enhancing the imaging quality of the optical lens system for image taking 1. Moreover, the image-side surface 132 comprises at least one inflection point for reducing the angle of incidence on the image plane 150, and, therefore, correcting the off-axis aberrations.

The optical lens system for image taking 1 satisfies the following conditions:

0.6<T₁₂/T₂₃<2.55; (Condition 1):

−0.8<R₃/R₄<0; (Condition 2):

−1.05<f/f₂<−0.1; and (Condition 3):

0<|f/f₃|<0.55; (Condition 4):

wherein T₁₂ is the axial distance between the first lens element 110 and the second lens element 120; T₂₃ is the axial distance between the second lens element 120 and the third lens element 130; R₃ is the curvature radius of the object-side surface 121; R₄ is the curvature radius of the image-side surface 122; f is the focal length of the optical lens system for image taking 1; f₂ is the focal length of the second lens element 120; and f₃ is the focal length of the third lens element 130.

When Condition 1 is satisfied, the spacing of the optical lens system for image taking 1 is well allocated which effectively corrects the aberrations as well as maintain a better total optical length. Moreover, when Condition 1 is satisfied, the optical lens system for image taking 1 is favorable for the assembly between each of the lens elements. In some embodiments, the relation of 0.7<T₁₂/T₂₃<1.8 is satisfied. When Condition 2 is satisfied, both the object-side surface 121 and the image-side surface 122 have an appropriate curvature radius for correcting the Petzval Sum. In some embodiments, the second lens element 120 satisfies −0.25<R₃/R₄<0.0.

Satisfying Condition 3 is favorable for effectively correcting the aberrations of the optical lens system for image taking 1. When Condition 4 is satisfied, the refractive power of the third lens element 130 is favorable for correcting the aberrations and reducing the total optical length of the optical lens system for image taking 1 according to the demand for the optical lens system for image taking 1. In some embodiments, the optical lens system for image taking 1 and the third lens element 130 satisfy 0<|f/f₃|<0.45.

Furthermore, the optical lens system for image taking 1 satisfies the following conditions:

0.85<f/f₁<1.65; (Condition 5):

−2.0<(R₁+R₂)/(R₁−R₂)<−0.5; (Condition 6):

0.2<R₆/f<0.8; (Condition 7):

29<V₁−V₂<50; (Condition 8):

TTL/ImgH<2.0; (Condition 9):

N₂>1.60; and (Condition 10):

V₂<25; (Condition 11):

wherein f is the focal length of the optical lens system for image taking 1; f₁ is the focal length of the first lens element 110; R₁ is the curvature radius of the object-side surface 111; R₂ is the curvature radius of the image-side surface 112; R₆ is the curvature radius of the image-side surface 132; V₁ is the Abbe number of the first lens element 110; V₂ is the Abbe number of the second lens element 120; TTL is the axial distance between the object-side surface 111 and the image plane 150; ImgH is a maximal image height of the optical lens system for image taking 1, in this embodiment, as well as a half of the diagonal length of the effective photosensitive area of the image sensor 160; and N₂ is the refractive index of the second lens element. 120.

When Condition 5 is satisfied, an allocation of the refractive power of the first lens element 110 is balanced to effectively control the total optical length of the optical lens system for image taking 1 as well as prevent the excessively high aberrations, therefore, achieving the miniaturization and improving the imaging quality. In some embodiments, the optical lens system for image taking 1 and the first lens element 110 satisfy 1.00<f/f₁<1.47. Satisfying Condition 6 is favorable for correcting the spherical aberration of the optical lens system for image taking 1.

Satisfying Condition 7 is favorable for making the principal point farther away from the image plane 150, and, therefore, reducing the total optical length of the optical lens system for image taking 1. Satisfying Condition 8 is favorable for correcting the chromatism. Satisfying Condition 9 is favorable for the miniaturization of the optical lens system for image taking 1. When Condition 10 is satisfied, the second lens element 120 is favorable for correcting the aberrations. When Condition 11 is satisfied, the second lens element 120 is favorable for correcting the chromatism generated by the optical lens system for image taking 1, therefore, increasing the resolution of the optical lens system for image taking 1.

In the optical lens system for image taking 1 of the present disclosure, all the lens elements may be made of plastic for reducing manufacturing costs. In addition, at least one of the surfaces of the second lens element is aspheric and that of the third lens element is aspheric and can be easily made into aspherical profiles, allowing more design parameter freedom for reducing aberrations and the total track length of the optical lens system for image taking 1 effectively.

In addition, in the optical lens system for image taking 1, a convex surface means the surface at a paraxial site is convex; a concave surface means the surface at a paraxial site is concave.

Furthermore, for eliminating the stray light to improve the imaging quality or limiting the object image to a desirable size, at least one stop, such as a glare stop or field stop, may be disposed in front of the first lens element 110, between any two lens elements or before the image plane 150. Furthermore, the optical lens system for image taking 1 can be utilized in applications of a three-dimensional optical system.

As for the optical lens system for image taking 1, the specific schemes are further described with the following embodiments. Parameters in the embodiments are defined as follows. Fno is an f-number value of the optical lens system for image taking 1, and HFOV is half of maximal field of view in the optical lens system for image taking 1. The aspheric surface in the embodiments may be represented by, but not limited to, the following aspheric surface equation (Condition ASP):

$$X ( Y ) = ( {Y}^{2} / R ) / ( 1 + sqrt ( 1 - ( 1 + k ) * {( Y / R )}^{2} ) ) + {\sum }_{i} ( Ai ) * ( {Y}^{i} )$$

Wherein Y is the distance from the point on the curve of the aspheric surface to the optical axis, X is the distance of a point on the aspheric surface at a distance Y from the optical axis relative to the tangential plane at the aspheric surface vertex, k is a conic factor, Ai is an i^{th} order aspheric surface coefficient, and in the embodiments, i may be, but is not limited to, 4, 6, 8, 10, 12, 14 and 16.

### The First Embodiment

### Embodiment 1

FIG. 1A is a schematic structural view of the first embodiment of the optical lens system for image taking. The optical lens system for image taking 1 comprises, from an object side to an image side along an optical axis (from left to right in FIG. 1A) in sequence, a stop, a first lens element 110, a second lens element 120, a third lens element 130, an infrared filter 140 and an image sensor 160 disposed on an image plane 150. The stop can be an aperture stop 100

In this embodiment, light having the reference wavelength of 587.6 nm is incident on the optical lens system for image taking 1. However, the reference wavelength of the light does not intend to limit the disclosure. In some embodiments, light with different wavelengths is used based on various demands.

In this embodiment, the first lens element 110 with positive refractive power has a convex aspheric object-side surface 111 and a concave aspheric image-side surface 112. The second lens element 120 with negative refractive power has a concave aspheric object-side surface 121 and a concave aspheric image-side surface 122. The third lens element 130 with negative refractive power has a convex aspheric object-side surface 131 and a concave aspheric image-side surface 132 with at least one inflection point.

The detailed data of the optical lens system for image taking 1 is as shown in Table 1-1 below:

TABLE 1-1
Embodiment 1
f = 2.25 mm, Fno = 2.80, HFOV = 31.8 deg.

| | | Curvature radius | Thickness | | | | Focal length |
|---|---|---|---|---|---|---|---|
| Surface # | | (mm) | (mm) | Material | Index | Abbe # | (mm) |
| 0 | Object | Plano | Infinity | | | | |
| 1 | Ape. | Plano | −0.113 | | | | |
| | Stop | | | | | | |
| 2 | Lens 1 | 0.680790(ASP) | 0.386 | Plastic | 1.544 | 55.9 | 1.60 |
| 3 | | 2.474610(ASP) | 0.217 | | | | |
| 4 | Lens 2 | −1.991150(ASP) | 0.426 | Plastic | 1.640 | 23.3 | −2.95 |
| 5 | | 38.986400(ASP) | 0.229 | | | | |
| 6 | Lens 3 | 1.958650(ASP) | 0.704 | Plastic | 1.544 | 55.9 | −19.3 |
| 7 | | 1.442210(ASP) | 0.200 | | | | |
| 8 | IR-cut | Plano | 0.200 | Glass | 1.517 | 64.2 | — |
| | filter | | | | | | |
| 9 | | Plano | 0.208 | | | | |
| 10 | Image | Plano | — | | | | |
| | Plane | | | | | | |

Note:
Reference wavelength is d-line 587.6 nm, and ASP represents aspheric.

In Table 1-1, from the object-side surface 111 to the image-side surface 132, all the surfaces can be aspheric, and the aspheric surfaces can satisfy Condition ASP, but are not limited thereto. As for the parameters of the aspheric surfaces, reference is made to Table 1-2 below:

Table 1-2
Aspheric Coefficients

| Surface # | 2 | 3 | 4 |
|---|---|---|---|
| k= | −5.87580E−02 | 7.81649E+00 | −7.26353E+00 |
| A₄= | −1.51480E−01 | −2.14792E−01 | −9.96926E−01 |
| A₆= | 3.16227E+00 | 4.23529E−02 | −4.85348E+00 |
| A₈= | −1.79969E+01 | −1.01573E+01 | 2.25795E+01 |
| A₁₀= | 2.92019E+01 | −5.72342E+01 | 5.63016E+00 |
| A₁₂= | −3.12464E−02 | −8.18633E−08 | −1.53435E+03 |
| Surface # | 5 | 6 | 7 |
| k= | −1.00000E+00 | −3.27216E+01 | −6.02013E+00 |
| A₄= | −8.23543E−01 | −8.68259E−01 | −4.35077E−01 |
| A₆= | 2.40178E+00 | 6.18470E−01 | 3.53978E−01 |
| A₈= | −7.49821E−01 | −1.22997E−01 | −3.67682E−01 |
| A₁₀= | −1.06877E+01 | −3.11998E−01 | 1.55390E−01 |
| A₁₂= | 2.37805E+01 | −9.98678E−01 | 7.90556E−03 |
| A₁₄= | — | 4.48467E−01 | −2.38763E−02 |
| A₁₆= | — | 3.47262 | 2.04977E−03 |

In Table 1-1, the curvature radius, the thickness and the focal length are shown in millimeters (mm). Surface numbers 0-10 represent the surfaces sequentially arranged from the object-side to the image-side along the optical axis. “f” stands for the focal length, “Fno” is the f-number, and “HFOV” is half of maximal field of view of this embodiment. In Table 1-2, k represents the conic coefficient of the equation of the aspheric surface profiles. A1-A16 represent the aspheric coefficients ranging from the 1^{st} order to the 16^{th} order. All labels for Tables of the remaining embodiments share the same definitions as those in Table 1-1 and Table 1-2 of the first embodiment, and their definitions will not be stated again.

The content of Table 1-3 may be deduced from Table 1-1:

TABLE 1-3
Embodiment 1

| | | | |
|---|---|---|---|
| f (mm) | 2.25 | (R₁ + R₂)/(R₁ − R₂) | −1.76 |
| Fno | 2.80 | R₃/R₄ | −0.05 |
| HFOV(deg.) | 31.8 | R₆/f | 0.64 |
| N₂ | 1.64 | f/f₁ | 1.40 |
| V₂ | 23.3 | f/f₂ | −0.76 |
| V₁-V₂ | 32.6 | \|f/f₃\| | 0.12 |
| T₁₂/T₂₃ | 0.95 | TTL/ImgH | 1.74 |

It can be observed from Table 1-3 that T₁₂/T₂₃ equals 0.95 which satisfies Condition 1; R₃/R₄ equals −0.05 which satisfies Condition 2; f/f₂ equals −0.76 which satisfies Condition 3; If/f₃| equals 0.12 which satisfies Condition 4; f/f₁ equals 1.40 which satisfies Condition 5.

(R₁+R₂)/(R₁−R₂) equals −1.76 which satisfies Condition 6; R₆/f equals 0.64 which satisfies Condition 7; V₁-V₂ equals 32.6 which satisfies Condition 8; TTL/ImgH equals 1.74 which satisfies Condition 9; N₂ equals 1.64 which satisfies Condition 10; V₂ equals 23.3 which satisfies Condition 11.

Referring to FIG. 1B, FIG. 1B is a schematic view of longitudinal spherical aberration curves when the lights having wavelengths of 486.1 nm (L), 587.6 nm (M), and 656.3 nm (N) are respectively projected in the optical lens system for image taking 1 in FIG. 1A.

Referring to FIG. 1C, FIG. 1C is a schematic view of astigmatic field curves from a tangential plane (T) and a sagittal plane (S). Horizontal axis is the focus position (mm), and vertical axis is the image height (mm).

Referring to FIG. 1D, FIG. 1D is a schematic view of a distortion curve in the optical lens system for image taking 1 in FIG. 1A. Regarding the relevant schematic views of the second embodiment to the eighth embodiment, the symbols are substantially the same as that in the first embodiment, which will not be repeated herein for conciseness.

### The Second Embodiment

### Embodiment 2

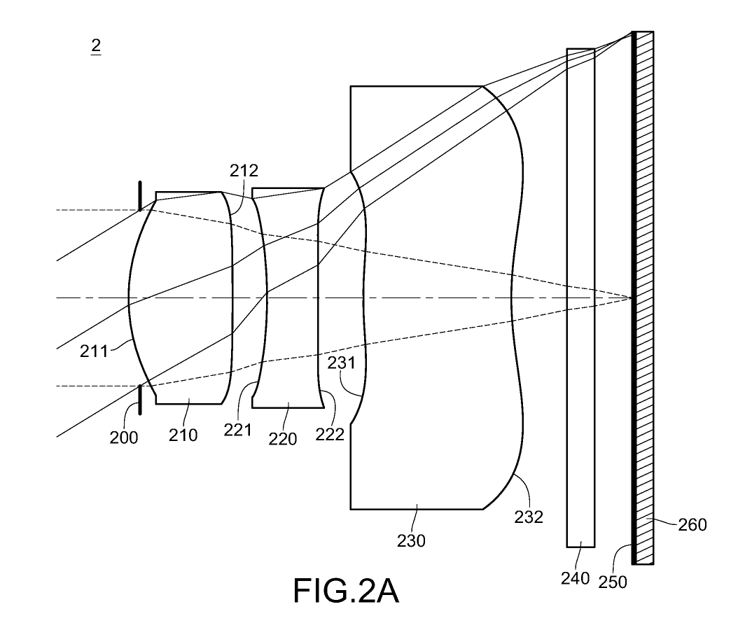

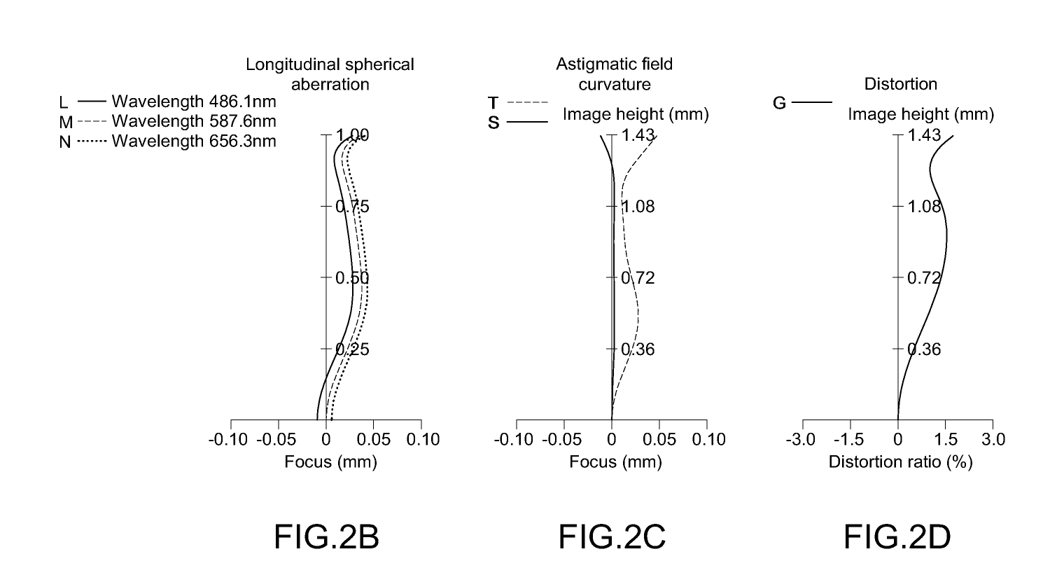

FIG. 2A is a schematic structural view of the second embodiment of the optical lens system for image taking. The specific implementation and elements of the second embodiment are substantially the same as those in the first embodiment. The element symbols in the second embodiment all begin with “2” which correspond to those in the first embodiment with the same function or structure. For conciseness, only the differences are illustrated below, and the similarities will not be repeated herein.

In this embodiment, the first lens element 210 with positive refractive power has a convex aspheric object-side surface 211 and a convex aspheric image-side surface 212. The second lens element 220 with negative refractive power has a concave aspheric object-side surface 221 and a concave aspheric image-side surface 222. The third lens element 230 with negative refractive power has a convex aspheric object-side surface 231 and a concave aspheric image-side surface 232 with at least one inflection point.

The detailed data of the optical lens system for image taking 2 is as shown in Table 2-1 below:

TABLE 2-1
Embodiment 2
f = 2.29, Fno = 2.40, HFOV = 31.4 deg.

| | | Curvature radius | Thickness | | | | Focal length |
|---|---|---|---|---|---|---|---|
| Surface # | | (mm) | (mm) | Material | Index | Abbe # | (mm) |
| 0 | Object | Plano | Infinity | | | | |
| 1 | Ape. | Plano | −0.062 | | | | |
| | Stop | | | | | | |
| 2 | Lens 1 | 0.955300(ASP) | 0.562 | Plastic | 1.544 | 55.9 | 1.72 |
| 3 | | −42.553200(ASP) | 0.187 | | | | |
| 4 | Lens 2 | −2.582680(ASP) | 0.276 | Plastic | 1.650 | 21.4 | −3.52 |
| 5 | | 20.920500(ASP) | 0.245 | | | | |
| 6 | Lens 3 | 2.163060(ASP) | 0.800 | Plastic | 1.535 | 56.3 | −35.08 |
| 7 | | 1.689490(ASP) | 0.300 | | | | |
| 8 | IR-cut | Plano | 0.150 | Glass | 1.517 | 64.2 | — |
| | filter | | | | | | |
| 9 | | Plano | 0.202 | | | | |
| 10 | Image | Plano | — | | | | |
| | Plane | | | | | | |

Note:
Reference wavelength is d-line 587.6 nm, and ASP represents aspheric.

In Table 2-1, from the object-side surface 211 to the image-side surface 232, all the surfaces can be aspheric, and the aspheric surfaces can satisfy Condition ASP, but are not limited thereto. As for the parameters of the aspheric surfaces, reference is made to Table 2-2 below.

TABLE 2-2
Aspheric Coefficients

| Surface # | 2 | 3 | 4 |
|---|---|---|---|
| k = | −2.56532E−01 | −1.00000E+00 | 7.44507E+00 |
| A₄ = | −1.05546E−01 | −1.19176E−01 | −5.70341E−01 |
| A₆ = | 1.64955E+00 | −1.78139E+00 | 6.36819E+00 |
| A₈ = | −1.56685E+01 | 1.35731E+01 | −3.46375E+01 |
| A₁₀ = | 6.44130E+01 | −5.39578E+01 | 1.10357E+02 |
| A₁₂ = | −1.04498E+02 | 5.43078E+01 | −1.78593E+02 |
| Surface # | 5 | 6 | 7 |
| k = | −1.00000E+00 | −1.66285E+00 | −1.75162E+00 |
| A₄ = | −6.64474E−01 | −1.11538E+00 | −3.98801E−01 |
| A₆ = | 3.87626E+00 | 1.40261E+00 | 1.73359E−01 |
| A₈ = | −5.47240E+00 | −2.04787E+00 | 1.51367E−02 |
| A₁₀ = | 6.39273E+00 | 5.54192E−01 | −1.52682E−01 |
| A₁₂ = | −6.87603E+00 | 2.27872E+00 | 4.69908E−02 |
| A₁₄ = | — | −7.25187E−01 | 4.51233E−02 |
| A₁₆ = | — | −4.52584E+00 | −2.42477E−02 |

The content of Table 2-3 may be deduced from Table 2-1.

TABLE 2-3
Embodiment 2

| | | | |
|---|---|---|---|
| f (mm) | 2.29 | (R₁ + R₂)/(R₁ − R₂) | −0.96 |
| Fno | 2.40 | R₃/R₄ | −0.12 |
| HFOV (deg.) | 31.4 | R₆/f | 0.74 |
| N₂ | 1.65 | f/f₁ | 1.33 |
| V₂ | 21.4 | f/f₂ | −0.65 |
| V₁-V₂ | 34.5 | \|f/f₃\| | 0.07 |
| T₁₂/T₂₃ | 0.76 | TTL/ImgH | 1.86 |

### The Third Embodiment

### Embodiment 3

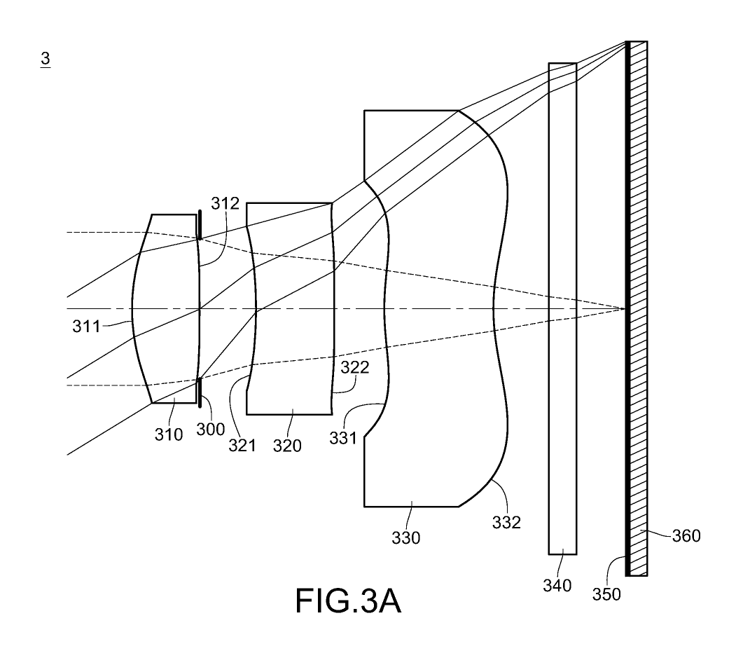

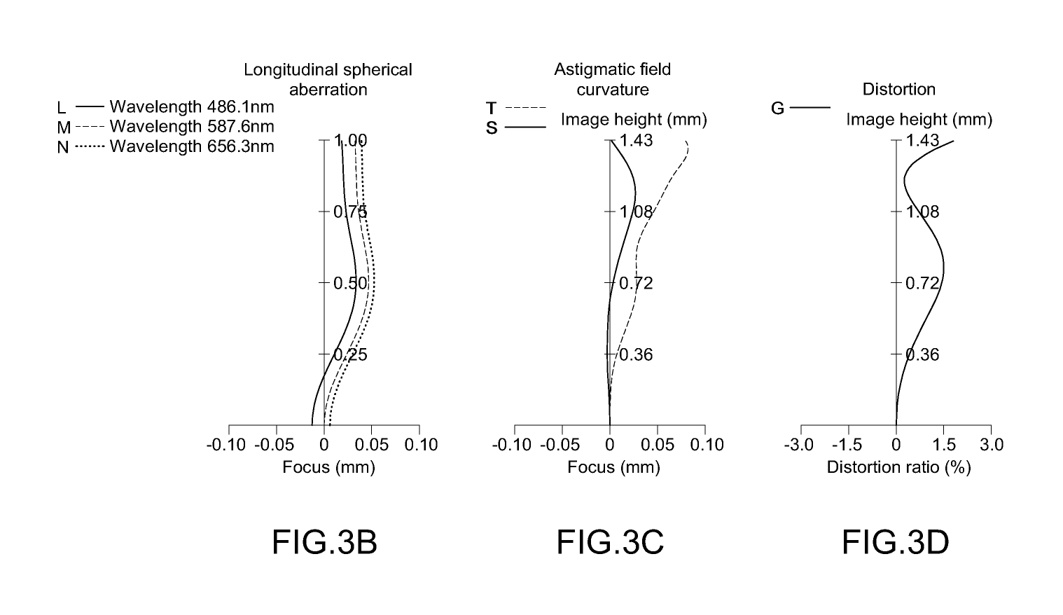

FIG. 3A is a schematic structural view of the third embodiment of the optical lens system for image taking. The specific implementation and elements of the third embodiment are substantially the same as those in the first embodiment. The element symbols in the third embodiment all begin with “3” which correspond to those in the first embodiment with the same function or structure. For conciseness, only the differences are illustrated below, and the similarities will not be repeated herein.

In this embodiment, the first lens element 310 with positive refractive power has a convex aspheric object-side surface 311 and a convex aspheric image-side surface 312. The second lens element 320 with negative refractive power has a concave aspheric object-side surface 321 and a concave aspheric image-side surface 322. The third lens element 330 with negative refractive power has a convex aspheric object-side surface 331 and a concave aspheric image-side surface 332 with at least one inflection point. The stop 300 is disposed between the first lens element 310 and the second lens element 320.

The detailed data of the optical lens system for image taking 3 is as shown in Table 3-1 below.

TABLE 3-1
Embodiment 3
f = 2.28 mm, Fno = 2.75, HFOV = 31.4 deg.

| | | Curvature radius | Thickness | | | | Focal length |
|---|---|---|---|---|---|---|---|
| Surface # | | (mm) | (mm) | Material | Index | Abbe # | (mm) |
| 0 | Object | Plano | Infinity | | | | |
| 1 | Lens 1 | 1.014020(ASP) | 0.365 | Plastic | 1.544 | 55.9 | 1.79 |
| 2 | | −21.978000(ASP) | 0.003 | | | | |
| 3 | Ape. | Plano | 0.302 | | | | |
| | Stop | | | | | | |
| 4 | Lens 2 | −2.911180(ASP) | 0.423 | Plastic | 1.640 | 23.3 | −3.78 |
| 5 | | 15.197600(ASP) | 0.271 | | | | |
| 6 | Lens 3 | 1.380470(ASP) | 0.590 | Plastic | 1.535 | 56.3 | −60.75 |
| 7 | | 1.127030(ASP) | 0.300 | | | | |
| 8 | IR-cut | Plano | 0.150 | Glass | 1.517 | 64.2 | — |
| | filter | | | | | | |
| 9 | | Plano | 0.266 | | | | |
| 10 | Image | Plano | — | | | | |
| | Plane | | | | | | |

Note:
Reference wavelength is d-line 587.6 nm, and ASP represents aspheric.

In Table 3-1, from the object-side surface 311 to the image-side surface 332, all surfaces can be aspheric, and the aspheric surfaces can satisfy Condition ASP, but are not limited thereto. As for the parameters of the aspheric surfaces, reference is made to Table 3-2 below.

TABLE 3-2
Aspheric Coefficients

| Surface # | 1 | 2 | 4 |
|---|---|---|---|
| k = | −5.77114E−01 | −1.00000E+00 | 1.28005E+01 |
| A₄ = | −2.24717E−01 | −3.13121E−01 | −7.75738E−01 |
| A₆ = | 1.76418E+00 | −1.98534E+00 | 6.35461E+00 |
| A₈ = | −1.82423E+01 | 1.06346E+01 | −4.59608E+01 |
| A₁₀ = | 6.08832E+01 | −5.28464E+01 | 1.83468E+02 |
| A₁₂ = | −9.44021E+01 | 9.57745E+01 | −2.82457E+02 |
| Surface # | 5 | 6 | 7 |
| k = | −1.00000E+00 | −2.67480E+00 | −4.78967E+00 |
| A₄ = | −1.06213E+00 | −1.41588E+00 | −5.06485E−01 |
| A₆ = | 4.28857E+00 | 1.02031E+00 | 3.30278E−01 |
| A₈ = | −8.68770E+00 | −1.12961E+00 | −2.91053E−01 |
| A₁₀ = | 8.54549E+00 | 3.42261E+00 | 1.59222E−01 |
| A₁₂ = | 7.90719E+00 | −1.02973E+01 | −1.03296E−01 |
| A₁₄ = | — | −1.24697E+01 | 5.52435E−03 |
| A₁₆ = | — | 4.19656E+01 | 1.94831E−02 |

The content of Table 3-3 may be deduced from Table 3-1.

TABLE 3-3
Embodiment 3

| | | | |
|---|---|---|---|
| f (mm) | 2.28 | (R₁ + R₂)/(R₁ − R₂) | −0.91 |
| Fno | 2.75 | R₃/R₄ | −0.19 |
| HFOV (deg.) | 31.4 | R₆/f | 0.50 |
| N₂ | 1.64 | f/f₁ | 1.27 |
| V₂ | 23.3 | f/f₂ | −0.60 |
| V₁-V₂ | 32.6 | f/f₃ | 0.04 |
| T₁₂/T₂₃ | 1.23 | TTL/ImgH | 1.83 |

### The Fourth Embodiment

### Embodiment 4

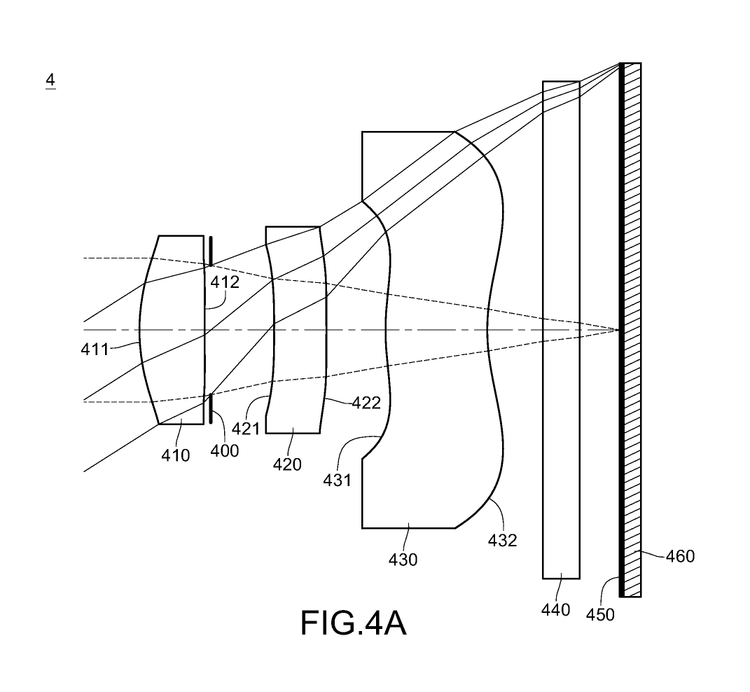

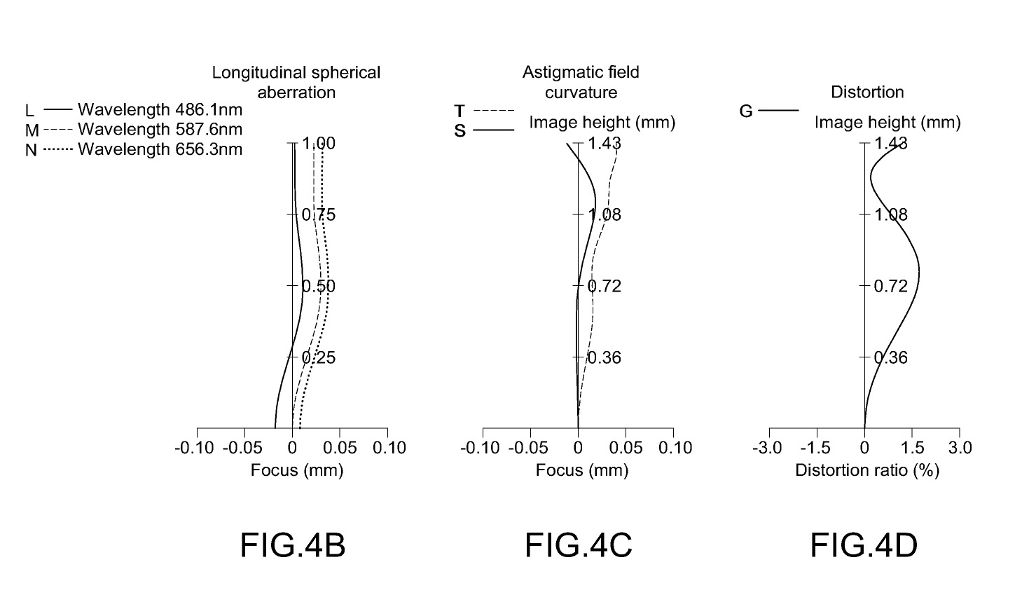

FIG. 4A is a schematic structural view of the fourth embodiment of the optical lens system for image taking. The specific implementation and elements of the fourth embodiment are substantially the same as those in the first embodiment. The element symbols in the fourth embodiment all begin with “4” which correspond to those in the first embodiment with the same function or structure. For conciseness, only the differences are illustrated below, and the similarities will not be repeated herein.

In this embodiment, the first lens element 410 with positive refractive power has a convex aspheric object-side surface 411 and a concave aspheric image-side surface 412. The second lens element 420 with negative refractive power has a concave aspheric object-side surface 421 and a concave aspheric image-side surface 422. The third lens element 430 with negative refractive power has a convex aspheric object-side surface 431 and a concave aspheric image-side surface 432 with at least one inflection point. The stop 400 is disposed between the first lens element 410 and the second lens element 420.

The detailed data of the optical lens system for image taking 4 is as shown in Table 4-1 below.

TABLE 4-1
Embodiment 4
f = 2.22 mm, Fno = 2.85, HFOV = 32.4 deg.

| | | Curvature radius | Thickness | | | | Focal length |
|---|---|---|---|---|---|---|---|
| Surface# | | (mm) | (mm) | Material | Index | Abbe # | (mm) |
| 0 | Object | Plano | Infinity | | | | |
| 1 | Lens 1 | 1.045140 (ASP) | 0.353 | Plastic | 1.544 | 55.9 | 2.05 |
| 2 | | 14.981000 (ASP) | 0.033 | | | | |
| 3 | Ape. | Plano | 0.343 | | | | |
| | Stop | | | | | | |
| 4 | Lens 2 | −7.400800 (ASP) | 0.282 | Plastic | 1.640 | 23.3 | −7.40 |
| 5 | | 13.333300 (ASP) | 0.320 | | | | |
| 6 | Lens 3 | 1.355010 (ASP) | 0.550 | Plastic | 1.535 | 56.3 | −25.34 |
| 7 | | 1.057620 (ASP) | 0.300 | | | | |
| 8 | IR-cut | Plano | 0.200 | Glass | 1.517 | 64.2 | — |
| | filter | | | | | | |
| 9 | | Plano | 0.216 | | | | |
| 10 | Image | Plano | — | | | | |
| | Plane | | | | | | |

Note:
Reference wavelength is d-line 587.6 nm, and ASP represents aspheric.

In Table 4-1, from the object-side surface 411 to the image-side surface 432, all surfaces can be aspheric, and the aspheric surfaces can satisfy Condition ASP, but are not limited thereto. As for the parameters of the aspheric surfaces, reference is made to Table 4-2 below.

TABLE 4-2
Aspheric Coefficients

| Surface # | 1 | 2 | 4 |
|---|---|---|---|
| k = | −8.86641E−01 | −1.00000E+00 | −1.00000E+00 |
| A4 = | −1.77531E−01 | −3.29325E−01 | −1.11581E+00 |
| A6 = | 1.48494E+00 | −1.62781E+00 | 6.06175E+00 |
| Ag = | −1.66780E+01 | 8.66294E+00 | −4.23500E+01 |
| A10 = | 5.90805E+01 | −4.22412E+01 | 1.58661E+02 |
| Al2 = | −9.03356E+01 | 6.99657E+01 | −2.13495E+02 |
| Surface # | 5 | 6 | 7 |
| k = | −1.00000E+00 | −4.35293E+00 | −4.35231E−01 |
| A4 = | −1.35859E+00 | −1.29452E+00 | −8.93165E−01 |
| A6 = | 4.91439E+00 | 1.10211E+00 | 6.26312E−01 |
| Ag = | −1.28544E+01 | −3.40313E+00 | −5.43714E−01 |
| A10 = | 1.73105E+01 | 5.86931E+00 | 3.29275E−01 |
| A12 = | 6.82867E+00 | 5.96793E+00 | −2.22480E−01 |
| A14 = | — | −5.93975E+01 | 7.23139E−02 |
| A16 = | — | 7.53259E+01 | 1.47506E−03 |

The content of Table 4-3 may be deduced from Table 4-1.

TABLE 4-3
Embodiment 4

| | | | |
|---|---|---|---|
| f (mm) | 2.22 | (R₁ + R₂)/(R₁ − R₂) | −1.15 |
| Fno | 2.85 | R₃/R₄ | −0.56 |
| HFOV(deg.) | 32.4 | R₆/f | 0.48 |
| N₂ | 1.64 | f/f₁ | 1.08 |
| V₂ | 23.3 | f/f₂ | −0.30 |
| V₁-V₂ | 32.6 | \|f/f₃\| | 0.09 |
| T₁₂/T₂₃ | 1.18 | TTL/ImgH | 1.76 |

### The Fifth Embodiment

### Embodiment 5

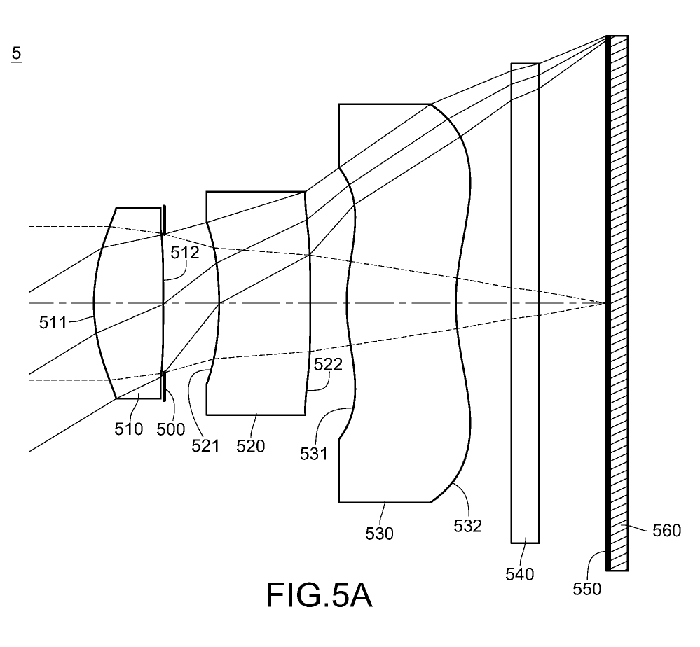

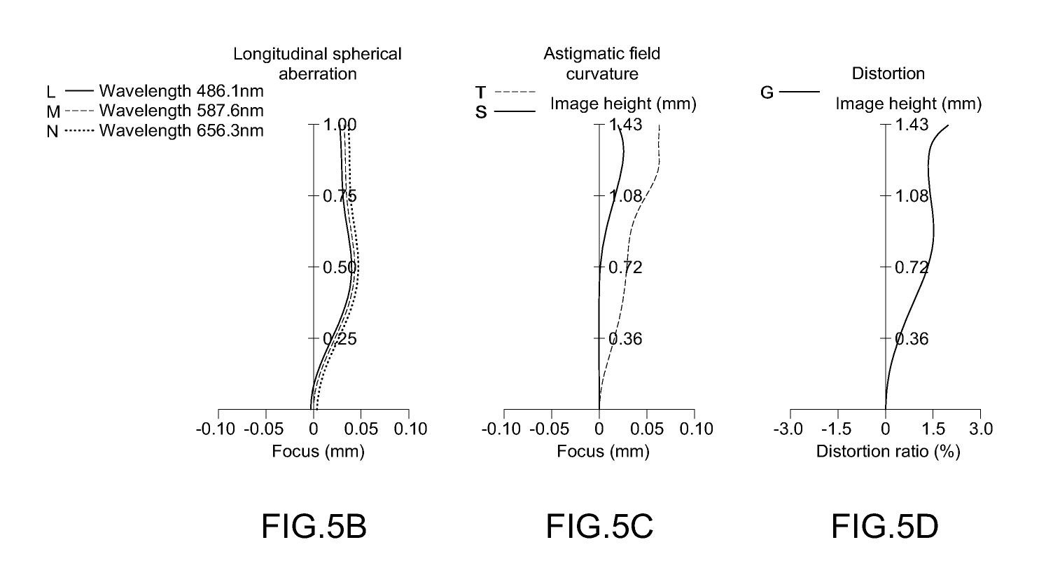

FIG. 5A is a schematic structural view of the fifth embodiment of the optical lens system for image taking. The specific implementation and elements of the fifth embodiment are substantially the same as those in the first embodiment. The element symbols in the fifth embodiment all begin with “5” which correspond to those in the first embodiment with the same function or structure. For conciseness, only the differences are illustrated below, and the similarities will not be repeated herein.

In this embodiment, the first lens element 510 with positive refractive power has a convex aspheric object-side surface 511 and a convex aspheric image-side surface 512. The second lens element 520 with negative refractive power has a concave aspheric object-side surface 521 and a concave aspheric image-side surface 522. The third lens element 530 with positive refractive power has a convex aspheric object-side surface 531 and a concave aspheric image-side surface 532 with at least one inflection point. The stop 500 is disposed between the first lens element 510 and the second lens element 520.

The detailed data of the optical lens system for image taking 5 is as shown in Table 5-1 below.

TABLE 5-1
Embodiment 5
f = 2.27 mm, Fno = 2.73, HFOV = 31.4 deg.

| | | Curvature Radius | Thickness | | | | Focal length |
|---|---|---|---|---|---|---|---|
| Surface# | | (mm) | (mm) | Material | Index | Abbe # | (mm) |
| 0 | Object | Plano | Infinity | | | | |
| 1 | Lens 1 | 0.987770 (ASP) | 0.375 | Plastic | 1.544 | 55.9 | 1.76 |
| 2 | | −28.169000 (ASP) | 0.006 | | | | |
| 3 | Ape. | Plano | 0.296 | | | | |
| | Stop | | | | | | |
| 4 | Lens 2 | −1.793340 (ASP) | 0.492 | Plastic | 1.650 | 21.4 | −2.44 |
| 5 | | 15.197600 (ASP) | 0.197 | | | | |
| 6 | Lens 3 | 0.999640 (ASP) | 0.590 | Plastic | 1.535 | 56.3 | 5.33 |
| 7 | | 1.223650 (ASP) | 0.300 | | | | |
| 8 | IR-cut | Plano | 0.150 | Glass | 1.517 | 64.2 | — |
| | filter | | | | | | |
| 9 | | Plano | 0.363 | | | | |
| 10 | Image | Plano | — | | | | |
| | Plane | | | | | | |

Note:
Reference wavelength is d-line 587.6 nm, ASP represents aspheric.

In Table 5-1, from the object-side surface 511 to image-side surface 532, all the surfaces can be aspheric, and the aspheric surfaces can satisfy Condition ASP, but are not limited thereto. As for the parameters of the aspheric surfaces, reference is made to Table 5-2 below.

TABLE 5-2
Aspheric Coefficients

| Surface # | 1 | 2 | 4 |
|---|---|---|---|
| k = | −3.46237E−01 | −1.00000E+00 | 5.75543E+00 |
| A₄ = | −1.90522E−01 | −2.38692E−01 | −5.67319E−01 |
| A₆ = | 1.88065E+00 | −1.84487E+00 | 6.06149E+00 |
| A₈ = | −1.83319E+01 | 1.15378E+01 | −4.87770E+01 |
| A₁₀ = | 6.35003E+01 | −6.66414E+01 | 2.06601E+02 |
| A₁₂ = | −9.94130E+01 | 1.32033E+02 | −3.42993E+02 |
| Surface # | 5 | 6 | 7 |
| k = | 3.00000E+00 | −8.51809E+00 | −8.82016E−01 |
| A₄ = | 1.30434E+00 | −8.44808E−01 | −6.70623E−01 |
| A₆ = | 4.98772E+00 | 5.00281E−01 | 4.01179E−01 |
| A₈ = | −9.09797E+00 | −1.54944E+00 | −2.51119E−01 |
| A₁₀ = | 6.26758E+00 | 5.85299E+00 | 1.29923E−01 |
| A₁₂ = | 6.17814E+00 | −6.35558E+00 | −9.31097E−02 |
| A₁₄ = | — | −1.31629E+01 | 1.63135E−02 |
| A₁₆ = | — | 2.17413E+01 | 4.84013E−03 |

The content of Table 5-3 may be deduced from Table 5-1.

TABLE 5-3
Embodiment 5

| | | | |
|---|---|---|---|
| f (mm) | 2.27 | (R₁ + R₂)/(R₁ − R₂) | −0.93 |
| Fno | 2.73 | R₃/R₄ | −0.12 |
| HFOV (deg.) | 31.5 | R₆/f | 0.54 |
| N₂ | 1.65 | f/f₁ | 1.29 |
| V₂ | 21.4 | f/f₂ | −0.93 |
| V₁-V₂ | 34.5 | \|f/f₃\| | 0.43 |
| T₁₂/T₂₃ | 1.53 | TTL/ImgH | 1.90 |

### The Sixth Embodiment

### Embodiment 6

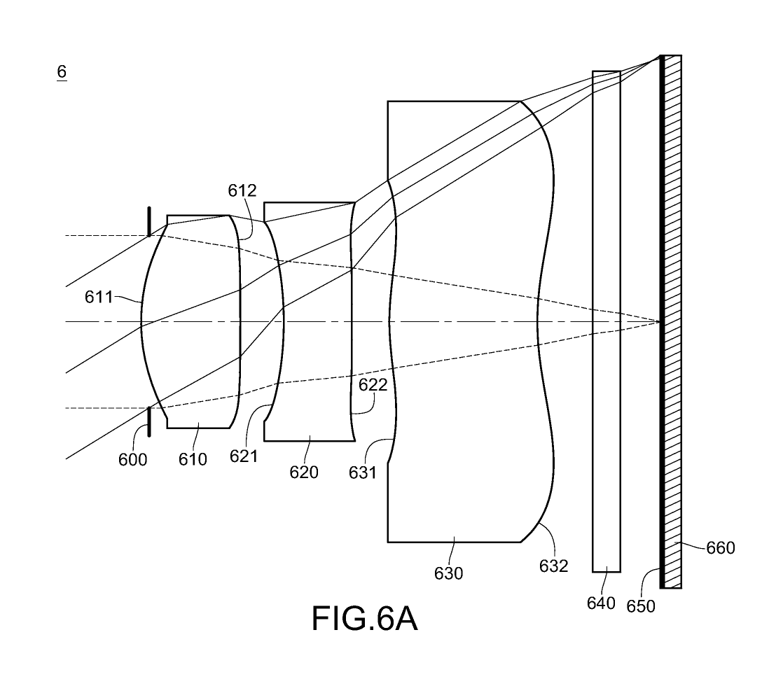

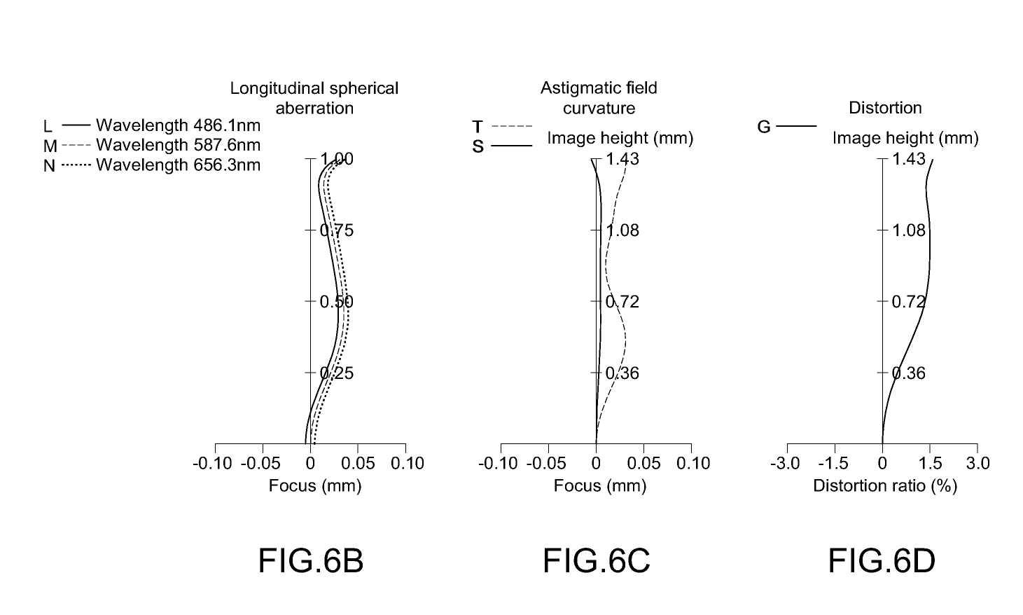

FIG. 6A is a schematic structural view of the sixth embodiment of the optical lens system for image taking. The specific implementation and elements of the sixth embodiment are substantially the same as those in the first embodiment. The element symbols in the sixth embodiment all begin with “6” which correspond to those in the first embodiment with the same function or structure. For conciseness, only the differences are illustrated below, and the similarities will not be repeated herein.

In this embodiment, the first lens element 610 with positive refractive power has a convex aspheric object-side surface 611 and a convex aspheric image-side surface 612. The second lens element 620 with negative refractive power has a concave aspheric object-side surface 621 and a concave aspheric image-side surface 622. The third lens element 630 with positive refractive power has a convex aspheric object-side surface 631 and a concave aspheric image-side surface 632 with at least one inflection point.

The detailed data of the optical lens system for image taking 6 is as shown in Table 6-1 below.

TABLE 6-1
Embodiment 6
f = 2.28 mm, Fno = 2.45, HFOV = 31.5 deg.

| | | Curvature Radius | Thickness | | | | Focal length |
|---|---|---|---|---|---|---|---|
| Surface# | | (mm) | (mm) | Material | Index | Abbe # | (mm) |
| 0 | Object | Plano | Infinity | | | | |
| 1 | Ape. | Plano | −0.043 | | | | |
| | Stop | | | | | | |
| 2 | Lens 1 | 0.985200 (ASP) | 0.536 | Plastic | 1.544 | 55.9 | 1.78 |
| 3 | | −42.553200 (ASP) | 0.235 | | | | |
| 4 | Lens 2 | −1.982370 (ASP) | 0.368 | Plastic | 1.650 | 21.4 | −2.72 |
| 5 | | 17.301000 (ASP) | 0.203 | | | | |
| 6 | Lens 3 | 1.352540 (ASP) | 0.800 | Plastic | 1.544 | 55.9 | 9.19 |
| 7 | | 1.467720 (ASP) | 0.300 | | | | |
| 8 | IR-cut | Plano | 0.150 | Glass | 1.517 | 64.2 | — |
| | filter | | | | | | |
| 9 | | Plano | 0.214 | | | | |
| 10 | Image | Plano | — | | | | |

Note:
Reference wavelength is d-line 587.6 nm, and ASP represents aspheric.

In Table 6-1, from the object-side surface 611 to the image-side surface 632, all surfaces can be aspheric, and the aspheric surfaces can satisfy Condition ASP, but are not limited thereto. As for the parameters of the aspheric surfaces, reference is made to Table 6-2 below.

TABLE 6-2
Aspheric Coefficients

| Surface # | 2 | 3 | 4 |
|---|---|---|---|
| k = | −2.32581E−01 | −1.00000E+00 | 6.07806E+00 |
| A₄ = | −1.00120E−01 | −6.86168E−02 | −4.57281E−01 |
| A₆ = | 1.63178E+00 | −1.87935E+00 | 5.66323E+00 |
| A₈ = | −1.54652E+01 | 1.31745E+01 | −3.38977E+01 |
| A₁₀ = | 6.43772E+01 | −5.16040E+01 | 1.11982E+02 |
| A₁₂ = | −1.07727E+02 | 5.07215E+01 | −1.80497E+02 |
| Surface # | 5 | 6 | 7 |
| k = | −1.00000E+00 | −2.36912E+00 | −1.04310E+00 |
| A₄ = | −9.02198E−01 | −1.17093E+00 | −4.00369E−01 |
| A₆ = | 4.04760E+00 | 1.79596E+00 | 1.21714E−01 |
| A₈ = | −6.18932E+00 | −1.79960E+00 | 9.83600E−02 |
| A₁₀ = | 5.98134E+00 | 1.65389E−01 | −1.60672E−01 |
| A₁₂ = | −3.73870E+00 | 1.68063E+00 | 2.63726E−02 |
| A₁₄ = | — | −3.94092E−01 | 4.39708E−02 |
| A₁₆ = | — | −1.66606E+00 | −1.88482E−02 |

The content of Table 6-3 may be deduced from Table 6-1.

TABLE 6-3
Embodiment 6

| | | | |
|---|---|---|---|
| f (mm) | 2.28 | (R₁ + R₂)/(R₁ − R₂) | −0.95 |
| Fno | 2.45 | R₃/R₄ | −0.11 |
| HFOV (deg.) | 31.5 | R₆/f | 0.64 |
| N₂ | 1.65 | f/f₁ | 1.29 |
| V₂ | 21.4 | f/f₂ | −0.84 |
| V₁-V₂ | 34.5 | \|f/f₃\| | 0.25 |
| T₁₂/T₂₃ | 1.16 | TTL/ImgH | 1.92 |

### The Seventh Embodiment

### Embodiment 7

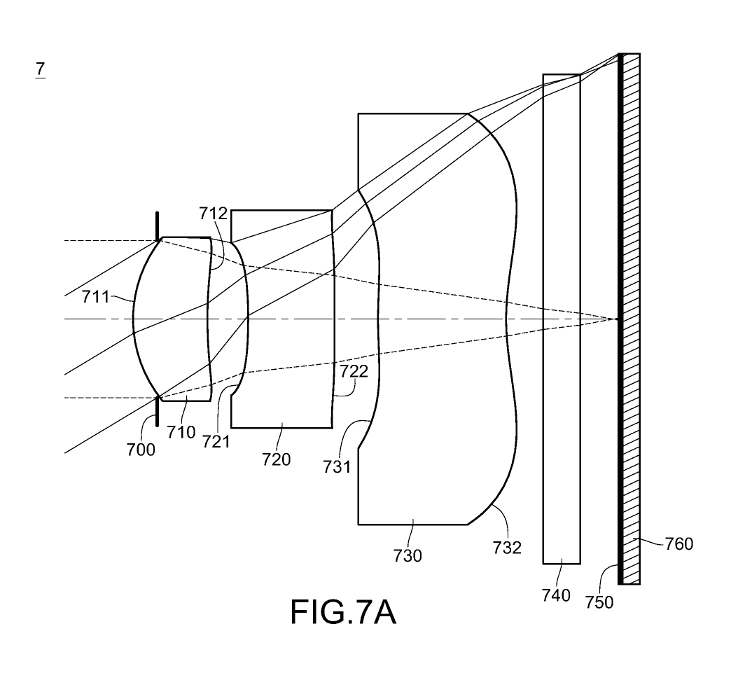

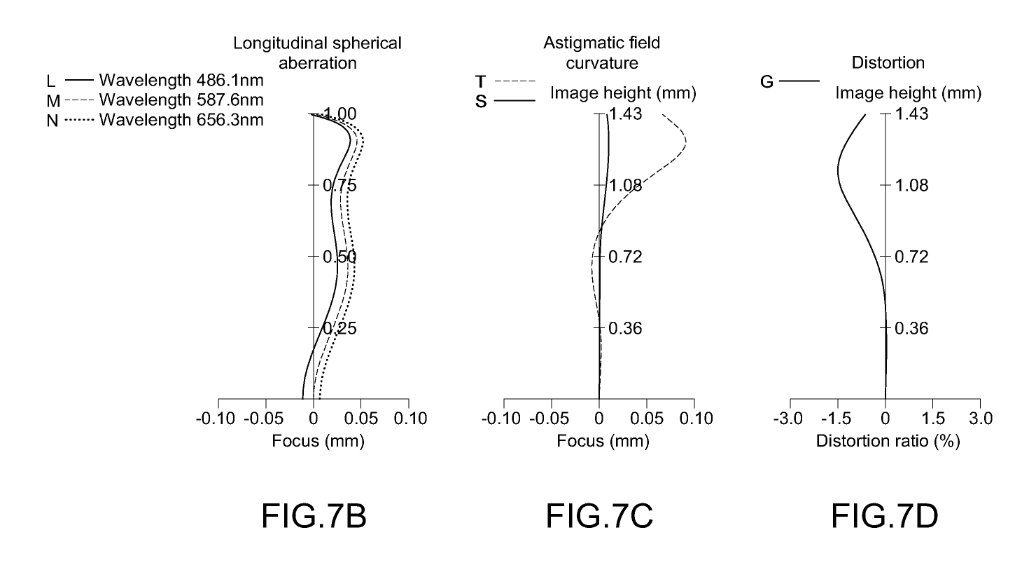

FIG. 7A is a schematic structural view of the seventh embodiment of the optical lens system for image taking. The specific implementation and elements of the seventh embodiment are substantially the same as those in the first embodiment. The element symbols in the seventh embodiment all begin with “7” which correspond to those in the first embodiment with the same function or structure. For conciseness, only the differences are illustrated below, and the similarities will not be repeated herein.

In this embodiment, the first lens element 710 with positive refractive power has a convex aspheric object-side surface 711 and a concave aspheric image-side surface 712. The second lens element 720 with negative refractive power has a concave aspheric object-side surface 721 and a concave aspheric image-side surface 722. The third lens element 730 with negative refractive power has a convex aspheric object-side surface 731 and a concave aspheric image-side surface 732 with at least one inflection point.

The detailed data of the optical lens system for image taking 7 is as shown in Table 7-1 below.

TABLE 7-1
Embodiment 7
f = 2.38 mm, Fno = 2.80, HFOV = 30.9 deg.

| | | Curvature Radius | Thickness | | | | Focal length |
|---|---|---|---|---|---|---|---|
| Surface# | | (mm) | (mm) | Material | Index | Abbe # | (mm) |
| 0 | Object | Plano | Infinity | | | | |
| 1 | Ape. | Plano | −0.130 | | | | |
| | Stop | | | | | | |
| 2 | Lens 1 | 0.686730 (ASP) | 0.402 | Plastic | 1.544 | 55.9 | 1.63 |
| 3 | | 2.390430 (ASP) | 0.221 | | | | |
| 4 | Lens 2 | −2.297090 (ASP) | 0.467 | Plastic | 1.650 | 21.4 | −3.30 |
| 5 | | 34.764500 (ASP) | 0.235 | | | | |
| 6 | Lens 3 | 2.606590 (ASP) | 0.693 | Plastic | 1.544 | 55.9 | −6.17 |
| 7 | | 1.330060 (ASP) | 0.200 | | | | |
| 8 | IR-cut | Plano | 0.200 | Glass | 1.517 | 64.2 | — |
| | filter | | | | | | |
| 9 | | Plano | 0.207 | | | | |
| 10 | Image | Plano | — | | | | |

Note:
Reference wavelength is d-line 587.6 nm, and ASP represents aspheric.

In Table 7-1, from the object-side surface 711 to the image-side surface 732, all surfaces can be aspheric, and the aspheric surfaces can satisfy Condition ASP, but are not limited thereto. As for the parameters of the aspheric surfaces, reference is made to Table 7-2 below.

TABLE 7-3
Aspheric Coefficients

| Surface # | 2 | 3 | 4 |
|---|---|---|---|
| k = | −1.59522E−01 | 6.79686E+00 | −2.11422E+01 |
| A₄ = | −1.51408E−01 | −1.73582E−01 | −8.92354E−01 |
| A₆ = | 3.22691E+00 | −1.64638E−01 | −4.51498E+00 |
| A₈ = | −1.53717E+ 01 | −4.24362E+00 | 9.13861E+00 |
| A₁₀ = | 2.19185E+01 | −5.61554E+01 | 1.31092E+02 |
| A₁₂ = | −3.12464E−02 | −7.22171E−08 | −1.53435E+03 |
| Surface # | 5 | 6 | 7 |
| k = | −1.00000E+ 00 | −7.30300E+01 | −1.06232E+01 |
| A₄ = | −7.52117E−01 | −1.04824E+00 | −4.25050E−01 |
| A₆ = | 2.45118E+00 | 9.35712E−01 | 3.59433E−01 |
| A₈ = | −9.00190E−01 | 1.73774E−01 | −3.65130E−01 |
| A₁₀ = | −1.14127E+ 01 | −8.35484E−01 | 1.52908E−01 |
| A₁₂ = | 2.36583E+01 | −2.27716E-00 | 7.60407E−03 |
| A₁₄ = | — | 6.31249E−02 | −1.68388E−02 |
| A₁₆ = | — | 7.63587E+00 | −4.94939E−03 |

The content of Table 7-3 may be deduced from Table 7-1.

TABLE 7-3
Embodiment 7

| | | | |
|---|---|---|---|
| f (mm) | 2.38 | (R₁ + R₂)/(R₁ − R₂) | −1.81 |
| Fno | 2.80 | R₃/R₄ | −0.07 |
| HFOV (deg.) | 30.9 | R₆/f | 0.56 |
| N₂ | 1.65 | f/f₁ | 1.46 |
| V₂ | 21.4 | f/f₂ | −0.72 |
| V₁-V₂ | 34.5 | \|f/f₃\| | 0.39 |
| T₁₂/T₂₃ | 0.94 | TTL/ImgH | 1.78 |

### The Eighth Embodiment

### Embodiment 8

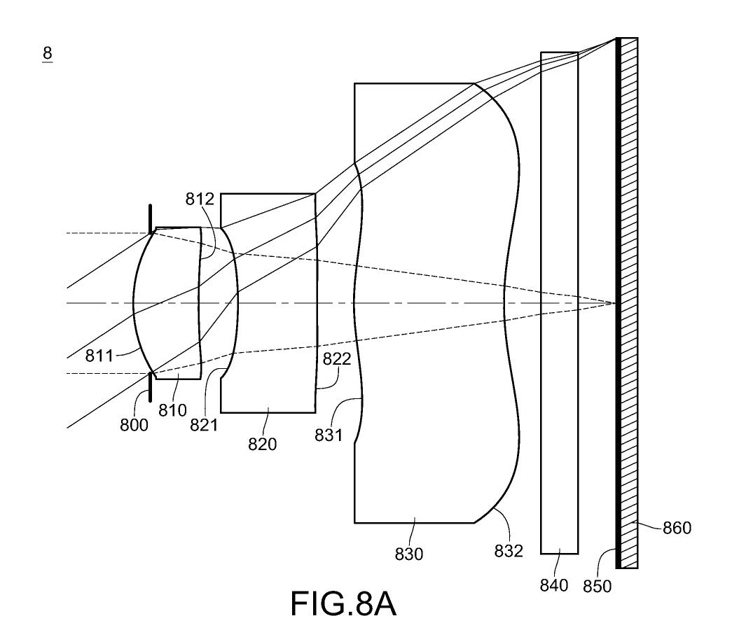

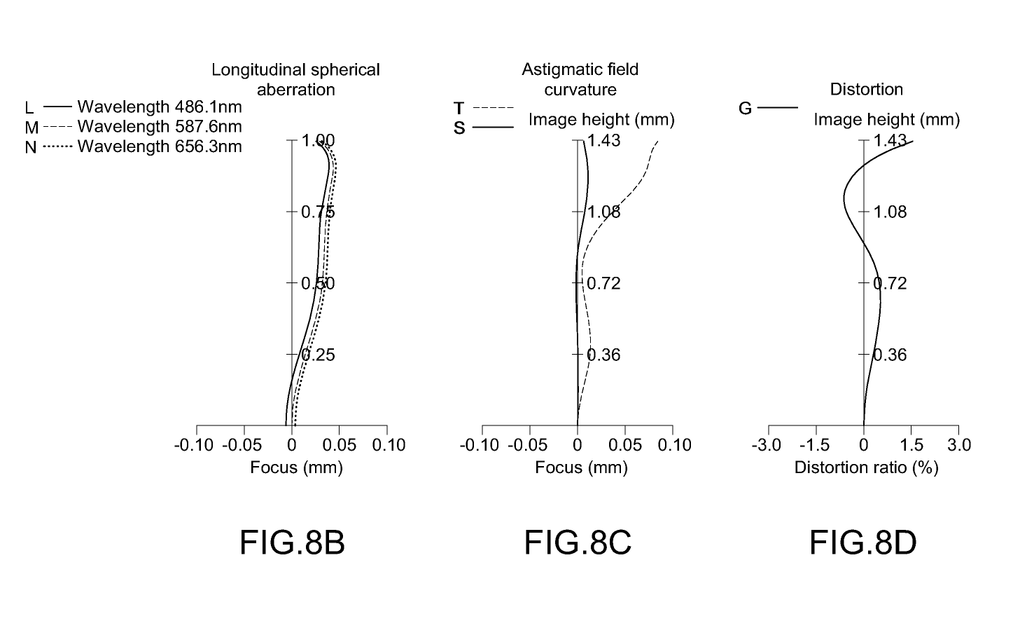

FIG. 8A is a schematic structural view of the eighth embodiment of the optical lens system for image taking. The specific implementation and elements of the eighth embodiment are substantially the same as those in the first embodiment. The element symbols in the eighth embodiment all begin with “8” which correspond to those in the first embodiment with the same function or structure. For conciseness, only the differences are illustrated below, and the similarities will not be repeated herein.

In this embodiment, the first lens element 810 with positive refractive power has a convex aspheric object-side surface 811 and a concave aspheric image-side surface 812. The second lens element 820 with negative refractive power has a concave aspheric object-side surface 821 and a concave aspheric image-side surface 822. The third lens element 830 with positive refractive power has a convex aspheric object-side surface 831 and a concave aspheric image-side surface 832 with at least one inflection point.

The detailed data of the optical lens system for image taking 8 is as shown in Table 8-1 below.

TABLE 8-1
Embodiment 8
f = 2.12 mm, Fno = 2.80, HFOV = 33.4 deg.

| | | Curvature Radius | Thickness | | | | Focal length |
|---|---|---|---|---|---|---|---|
| Surface# | | (mm) | (mm) | Material | Index | Abbe # | (mm) |
| 0 | Object | Plano | Infinity | | | | |
| 1 | Ape. | Plano | −0.092 | | | | |
| | Stop | | | | | | |
| 2 | Lens 1 | 0.714580 (ASP) | 0.353 | Plastic | 1.544 | 55.9 | 1.60 |
| 3 | | 3.270000 (ASP) | 0.213 | | | | |
| 4 | Lens 2 | −1.732050 (ASP) | 0.428 | Plastic | 1.640 | 23.3 | −2.25 |
| 5 | | 9.465200 (ASP) | 0.199 | | | | |
| 6 | Lens 3 | 1.249310 (ASP) | 0.811 | Plastic | 1.544 | 55.9 | 6.64 |
| 7 | | 1.473100 (ASP) | 0.200 | | | | |
| 8 | IR-cut | Plano | 0.200 | Glass | 1.517 | 64.2 | — |
| | filter | | | | | | |
| 9 | | Plano | 0.208 | | | | |
| 10 | Image | Plano | — | | | | |
| | Plane | | | | | | |

Note:
Reference wavelength is d-line 587.6 nm; ASP represents aspheric.

In Table 8-1, from the object-side surface 811 to the image-side surface 832, all surfaces can be aspheric, and the aspheric surfaces can satisfy Condition ASP, but are not limited thereto. As for the parameters of the aspheric surfaces, reference is made to Table 8-2 below.

TABLE 8-2
Aspheric Coefficients

| Surface # | 2 | 3 | 4 |
|---|---|---|---|
| k = | −3.77219E−02 | 1.68313E+01 | −1.01430E+01 |
| A₄ = | −1.34867E−01 | −1.36803E−01 | −8.96285E−01 |
| A₆ = | 3.36131E+00 | −1.74216E−02 | −3.98153E+00 |
| A₈ = | −1.83583E+01 | −5.54782E+00 | 1.82945E+01 |
| A₁₀ = | 2.66633E+01 | −7.38473E+01 | 7.04564E+01 |
| A₁₂ = | −3.12469E−02 | −4.64299E−08 | −1.53435E+03 |
| Surface # | 5 | 6 | 7 |
| k = | −1.00000E+00 | −2.63301E−01 | −2.63301E−01 |
| A₄ = | −9.12865E−01 | −4.73649E−01 | −4.73649E−01 |
| A₆ = | 2.78837E+00 | 2.89891E−01 | 2.89891E−01 |
| A₈ = | −4.47094E−01 | −2.77428E−01 | −2.77428E−01 |
| A₁₀ = | −1.24297E+01 | 1.31312E−01 | 1.31312E−01 |
| A₁₂ = | 1.98361E+01 | −6.78894E−03 | −6.78894E−03 |
| A₁₄ = | — | −2.27406E−02 | −2.27406E−02 |
| A₁₆ = | — | 5.41413E−03 | 5.41413E−03 |

The content of Table 8-3 may be deduced from Table 8-1.

TABLE 8-3
Embodiment 8

| | | | |
|---|---|---|---|
| f (mm) | 2.12 | (R₁ + R₂)/(R₁ − R₂) | −1.56 |
| Fno | 2.80 | R₃/R₄ | −0.18 |
| HFOV (deg.) | 33.4 | R₆/f | 0.69 |
| N₂ | 1.64 | f/f₁ | 1.32 |
| V₂ | 23.3 | f/f₂ | −0.94 |
| V₁-V₂ | 32.6 | \|f/f₃\| | 0.32 |
| T₁₂/T₂₃ | 1.07 | TTL/ImgH | 1.77 |

What is claimed is:

1. An optical lens system for image taking comprising, in order from an object side to an image side:
a first lens element with positive refractive power comprising a convex object-side surface;
a second lens element with negative refractive power comprising a concave object-side surface and a concave image-side surface, and at least one of the object-side surface and the image-side surface being aspheric; and
a third lens element with negative refractive power comprising a convex object-side surface and a concave image-side surface, at least one of the object-side surface and the image-side surface being aspheric, and the image-side surface comprising at least one inflection point;
the optical lens system for image taking satisfying the following condition:
0.6<T₁₂/T₂₃<2.55;
wherein T₁₂ is the axial distance between the first lens element and the second lens element, and T₂₃ is the axial distance between the second lens element and the third lens element.

2. The optical lens system for image taking according to claim 1, wherein the optical lens system for image taking satisfies the following condition:
0.85<f/f₁<1.65;
wherein f is the focal length of the optical lens system for image taking, and f₁ is the focal length of the first lens element.

3. The optical lens system for image taking according to claim 2, wherein the optical lens system for image taking satisfies the following condition:
−0.8<R₃/R₄<0;
wherein R₃ is the curvature radius of the object-side surface of the second lens element, and R₄ is the curvature radius of the image-side surface of the second lens element.

4. The optical lens system for image taking according to claim 3, wherein the first lens element comprises an image-side surface and the optical lens system for image taking satisfies the following condition:
−2.0<(R₁+R₂)/(R₁−R₂)<−0.5;
wherein R₁ is the curvature radius of the object-side surface of the first lens element, and R₂ is the curvature radius of the image-side surface of the first lens element.

5. The optical lens system for image taking according to claim 3, wherein the optical lens system for image taking satisfies the following condition:
0.7<T₁₂/T₂₃<1.8;
wherein T₁₂ is the axial distance between the first lens element and the second lens element, and T₂₃ is the axial distance between the second lens element and the third lens element.

6. The optical lens system for image taking according to claim 3, wherein the optical lens system for image taking satisfies the following condition:
0.2<R₆/f<0.8;
wherein R₆ is the curvature radius of the image-side surface of the third lens element, and f is the focal length of the optical lens system for image taking.

7. The optical lens system for image taking according to claim 3, wherein the optical lens system for image taking satisfies the following condition:
−1.05<f/f₂<−0.1;
wherein, f is the focal length of the optical lens system for image taking, and f₂ is the focal length of the second lens element.

8. The optical lens system for image taking according to claim 3, wherein the first lens element comprises an image-side surface, the object-side surfaces and the image-side surfaces of the first, second, and third lens elements are aspheric, and the first, second, and third lens elements are made of plastic.

9. The optical lens system for image taking according to claim 2, wherein the optical lens system for image taking satisfies the following condition:
29<V₁−V₂<50;
wherein V₁ is the Abbe number of the first lens element, and V₂ is the Abbe number of the second lens element.

10. The optical lens system for image taking according to claim 2, wherein the optical lens system for image taking satisfies the following condition:
1.00<f/f₁<1.47;
wherein f is the focal length of the optical lens system for image taking, and f₁ is the focal length of the first lens element.

11. The optical lens system for image taking according to claim 2, wherein the optical lens system for image taking further comprises an image plane and the optical lens system for image taking satisfies the following condition:
TTL/ImgH<2.0;
wherein TTL is the axial distance between the object-side surface of the first lens element and the image plane, and ImgH is a maximal image height of the optical lens system for image taking.

12. An optical lens system for image taking comprising, in order from an object side to an image side:
a first lens element with positive refractive power comprising a convex object-side surface;
a second lens element with negative refractive power comprising a concave object-side surface and a concave image-side surface, and both the object-side surface and the image-side surface being aspheric; and
a third lens element comprising a convex object-side surface and a concave image-side surface, and both the object-side surface and the image-side surface being aspheric;
the optical lens system for image taking satisfying the following condition:
0.6<T₁₂/T₂₃<2.55;
−0.8<R₃/R₄<0;
−1.05<f/f₂<−0.1; and
0<|f/f₃|<0.55;
wherein T₁₂ is the axial distance between the first lens element and the second lens element, T₂₃ is the axial distance between the second lens element and the third lens element, R₃ is the curvature radius of the object-side surface of the second lens element, R₄ is the curvature radius of the image-side surface of the second lens element, f is the focal length of the optical lens system for image taking, f₂ is the focal length of the second lens element, and f₃ is the focal length of the third lens element.

13. The optical lens system for image taking according to claim 12, wherein the second lens element and the third lens element are made of plastic, and the image-side surface of the third lens element comprises at least one inflection point.

14. The optical lens system for image taking according to claim 13, wherein the optical lens system for image taking satisfies the following condition:
1.00<f/f₁<1.47;
wherein f is the focal length of the optical lens system for image taking, and f₁ is the focal length of the first lens element.

15. The optical lens system for image taking according to claim 13, wherein the optical lens system for image taking satisfies the following condition:
0<|f/f₃|<0.45;
wherein f is the focal length of the optical lens system for image taking, and f₃ is the focal length of the third lens element.

16. The optical lens system for image taking according to claim 14, wherein the optical lens system for image taking satisfies the following condition:
0.7<T₁₂/T₂₃<1.8;
wherein T₁₂ is the axial distance between the first lens element and the second lens element, and T₂₃ is the axial distance between the second lens element and the third lens element.

17. The optical lens system for image taking according to claim 15, wherein the optical lens system for image taking satisfies the following condition:
−0.25<R₃/R₄<0.0;
wherein R₃ is the curvature radius of the object-side surface of the second lens element, R₄ is the curvature radius of the image-side surface of the second lens element.

18. The optical lens system for image taking according to claim 15, wherein the first lens element comprises a convex image-side surface.

19. The optical lens system for image taking according to claim 13, wherein the optical lens system for image taking satisfies the following condition:
29<V₁−V₂<50;
wherein V₁ is the Abbe number of the first lens element, and V₂ is the Abbe number of the second lens element.

20. The optical lens system for image taking according to claim 13, wherein the optical lens system for image taking satisfies the following condition:
N₂>1.60; and
V₂<25;
wherein N₂ is the refractive index of the second lens element, and V₂ is the Abbe number of the second lens element.

21. The optical lens system for image taking according to claim 13, wherein the optical lens system for image taking further comprises an image plane and the optical lens system for image taking satisfies the following condition:
TTL/ImgH<2.0;
wherein TTL is the axial distance between the object-side surface of the first lens element and the image plane, and ImgH is a maximal image height of the optical lens system for image taking.
